(19) United States
(12) Patent Application Publication
(10) Pub. No.: US 2012/0005169 A1
(43) Pub. Date: Jan. 5, 2012

(54) METHOD AND SYSTEM FOR SECURING DATA

(75) Inventors: Ashutosh SAXENA, Ahmedabad (IN); Tiruvengalam KANDURI, Hyderabad (IN)

(73) Assignee: INFOSYS TECHNOLOGIES LIMITED, Bangalore (IN)

(21) Appl. No.: 12/901,672

(22) Filed: Oct. 11, 2010

(30) Foreign Application Priority Data
Jul. 2, 2010 (IN) 1869/CHE/2010

(51) Int. Cl. G06F 17/30

(52) U.S. Cl. 707/687; 707/E17.007

(57) ABSTRACT

Disclosed are methods and computer program product for securing data corresponding to one or more data fields of a form by providing data integrity, confidentiality and non-repudiation. The present invention includes providing one or more controls for enabling selection of at least one security type for each of the data fields corresponding to the form. Further, at least one security routine is implemented for the data fields to produce corresponding secured data. The at least one security routine corresponds to the selected at least one security type. Further, a system for securing the data is also disclosed.

### FIELD OF THE INVENTION

The present invention relates, generally, to the field of data security and, more particularly, to selectively securing specific data fields.

### BACKGROUND

Every business involves utilization of data that needs to be kept confidential. Similarly, every individual also needs to keep some data confidential. With the emergence of the Internet, most of the transactions, monetary/non-monetary, are carried out electronically. For instance, while using an e-commerce application, such as an online shopping portal or an online bank account application, an individual usually needs to share confidential information to conduct a transaction. Such confidential information may include the individual's bank account number, credit card information, and identity related information such as Social Security Number (SSN), national passport data and similar personal information. Most of these applications use a secure environment to carry out transactions. However, there have been numerous instances where such sensitive information has been compromised in one way or the other.

Confidential information may be leaked through shoulder hacking; for instance, when an individual inputs a piece of information through a keyboard or any other medium for providing to the e-commerce applications on the websites. Currently, masking passwords provides safety to a password from shoulder hacking. However, an individual may wish to hide other information as well from being viewed by others. For example, employees may wish to hide their current salary and individuals may want to hide sensitive information such as account information; credit card information, identity related information such as passport number and other personal information. However, existing applications do not allow individuals to keep such information confidential. Thus, it becomes difficult for individuals to access such applications while in public or while surfing the Internet in cyber cafés and the like.

Also, it has become common for hackers to access confidential information. Further, in most of the applications, information is shared across servers. Typically, most identity-related information, such as SSN number and passport related information, needs to be transferred across servers for validating/authenticating other data provided by an individual. However, in most of the cases, the applications may not require any such information for being operated. In such cases, the information may be susceptible to being illegally accessed and misused, while being transmitted from one server to another.

In addition, signing operation requires a component to be downloaded. This component accesses the underlying cryptographic APIs to perform the signing operation. However, the component may be written with wrong intention that can sign any data without the individual knowing about the actual data that is getting signed. This can be a potential threat for the individual as legislations (such as Indian IT act 2000) consider digital signature to be equivalent to hand written signatures. Due to this, there is an apparent fear among individuals regarding the signing process.

Based on the above discussion, there is a need for a system to efficiently secure data for its effective handling in a simple manner. Further, the system should enable the individuals for securing data based upon their choices. Furthermore, the system should be capable of authenticating the data. Additionally, the system should provide safe components for applying security measures on the data. Also, the system should safely transfer/share confidential data across the servers to avoid any fraudulent use thereof. Thus, the system should provide abovementioned solutions to maintain integrity of the data and to overcome existing shortcomings in the field associated with the security of data.

### SUMMARY

The present invention provides a method for securing data corresponding to one or more data fields of a form by providing date integrity, confidentiality, and non-repudiation. The method includes providing one or more controls for enabling selection of at least one security type for each of the data fields in the form. The method further includes implementing at least one security routine for the selected data fields to produce corresponding secured data field. The at least one security routine corresponds to the selected at least one security type.

The present invention provides a system for securing data by providing data integrity, confidentiality, and non-repudiation. The system includes a core engine module and a routine module. The core engine module is configured for providing one or more controls for enabling selection of at least one security type for one or more data fields. The one or more data fields correspond to a form. Further, the routine module is configured for implementing at least one security routine for the one or more data fields to produce corresponding secured data field. The at least one security routine corresponds to the selected at least one security type.

The present invention provides a computer program product for use with a computer. The computer program product includes a computer-usable medium having a computer-readable program code embodied therein for maintaining data integrity, confidentiality, and non-repudiation. The data corresponds to one or more data fields of a form. The computer readable program code provides one or more controls for enabling selection of at least one security type for each of the one or more data fields. The one or more data fields correspond to the form. Further, the computer program code implements at least one security routine for the one or more data fields to produce corresponding secured data field. The at least one security routine corresponds to the selected at least one security type.

The present invention provides various controls for securing the data by maintaining data integrity, confidentiality, and non-repudiation. The controls enable a user to select one or more security types to secure data corresponding to a particular data field. The security types may include, but are not limited to, masking, signing, hashing, and encryption. Based on the selection, a security routine corresponding to the selected security type may be implemented, on the data, for producing secured data.

The invention provides numerous advantages for the user. The user gets a privilege of selecting a security type for a particular data field that needs to be secured. This increases the user's awareness about the exact portion of the data that is getting secured and about the security routine being implemented.

The system may be utilized for a secure transmission of the data across the servers. For example, the system may secure the data while transmitting the data from one server to another server and then to final receiving server. The system may provide various predefined options, to the user, corresponding to the selected security type. Such options may be utilized by the user to specify additional criteria for implementing the security routine. For example, if the user selects “encryption” as the security type, the user may choose one or more options, such as “encryption certificate”’, ‘encryption algorithm’ and the like, corresponding to “encryption”. Further, the user may choose a particular encryption certificate, such as a certificate corresponding to the final server where the data needs to be sent, from the available encryption certificates. Due to this, the data may not be altered at a server where the chosen encryption certificate is not in correspondence with the server's certificate. Thereby, the data may be prevented from alteration or misuse while transmitting from one server to the final receiving server.

### BRIEF DESCRIPTION OF THE DRAWINGS

The various embodiments of the invention will hereinafter be described in conjunction with the appended drawings, provided to illustrate, and not to limit, the invention, wherein like designations denote like elements, and in which:

FIG. 1 illustrates a block diagram of a system for securing data, in accordance with an embodiment of the invention;

FIG. 2 is a flowchart illustrating a method for securing one or more data fields, in accordance with an embodiment of the invention;

FIG. 3 illustrates an exemplary Web form for implementing the method, in accordance with an embodiment of the invention; and

FIG. 4 is an exemplary data structure for storing attributes corresponding to one or more data fields of the Web form, in accordance with an embodiment of the invention.

### DETAILED DESCRIPTION OF THE INVENTION

The present invention comprises a method, a system, and a computer program product for securing data by maintaining data integrity, confidentiality, and non-repudiation (hereinafter referred to as “securing data”). The data may correspond to one or more data entities such as data fields of a form. The form may include, but is not restricted to, a Web form, and a PDF form. A user may enter data in the data fields of the Web form. Thereafter, this data may be sent to a server for processing. Thus, in an exemplary embodiment, the Web forms may enable the system to be implemented in a client-server architecture. In this architecture, a client side interface may include a Web page that may be viewed by the user in a Web browser (hereinafter referred to as “browser”). The method may enable transmission of data between the browser and the server. Further, a request may be sent from the client side to the server to secure the data corresponding to the data fields. The user may select a particular data field of the form for requesting the server to apply a type of security measure (hereinafter referred to as a “security type”) for the data corresponding to the selected field. The security type may include, but is not restricted to, masking, signing, hashing, and encryption. Furthermore, based on the selection of the security type, a security routine may be implemented on the data to produce corresponding secured data for the data field. For example, if the user selects “masking” as the security type for the data, a masking routine may be implemented on the data to produce masked data. In an embodiment of the invention, the method, the system, and the computer program product enable the user secure the data corresponding to data fields of an application.

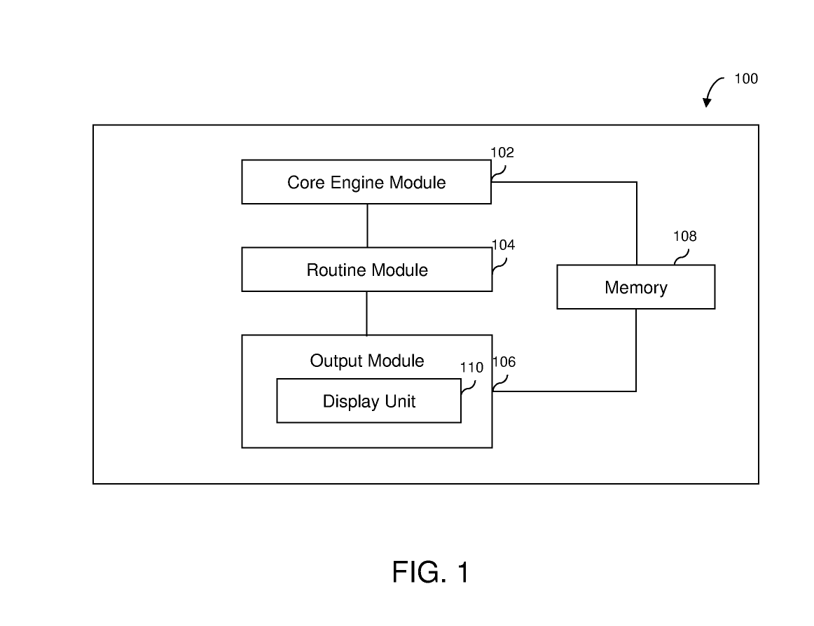

Further, the system may include various components that may be utilized for securing data. For example, the system may utilize a browser plug-in for securing the data. The browser plug-in may be utilized based on a contract that exists between the plug-in and the browser. Based on the contract, the plug-in may direct the browser to invoke a controller of the system for securing the data. The components are explained in detail in conjunction with FIG. 1

FIG. 1 illustrates a block diagram of a system 100 for securing data, in accordance with an embodiment of the invention. The data may be secured by maintaining integrity, confidentiality, and non-repudiation thereof. System 100 includes a core engine module 102, a routine module 104 communicably coupled to core engine module 102, an output module 106 communicably coupled to routine module 104, and a memory 108 communicably coupled to core engine module 102 and output module 106. Core engine module 102 may act as a controller of system100. The browser may invoke core engine module 102 on loading of a new Web page. The Web page may contain a form having one or more data fields.

Core engine module 102 may maintain a data structure for each data field. The data structure may store attributes corresponding to each data field. The attributes may include, but are not restricted to, name of the data fields and information corresponding to data associated with the data fields. The information may include, but is not restricted to, a security type (selected by the user) to be applied on the data, secured data after applying the security type on the data, and various features corresponding to the security type that is applied on the data. The security type may include at least one of “masking”, “signing”, “hashing”, and “encryption”.

Further, the various features may include one or more predefined options corresponding to the security type that the user may select for applying the security type on the data. For example, the one or more predefined options may include, but are not limited to, one or more encryption certificates and one or more signing certificates corresponding to the “encryption” and the “signing”, respectively. It may be appreciated by any person skilled in the art that system 100 may provide the one or more predefined options, to the user, corresponding to the security type that the user may wish to select corresponding to the selected security type.

The attributes, corresponding to the data fields, may be gathered by parsing the form. For this, in an embodiment, core engine module 102 may call a form parser (not shown) to parse the form and to generate a list of the attributes corresponding to the data fields present in the form. Further, the form parser may provide a list to core engine module 102. The list may then be utilized by core engine module 102 to maintain the data structure.

Core engine module 102 may provide one or more controls for each data field. Each control corresponds to a specific security type that the user may wish to apply on the data corresponding to the data field. The controls may include, but are not limited to, buttons that enable the user to select at least one of the given security types of his/her choice for the data fields. For example, a form may include three data fields, and the controls for different security types are provided against each field. These controls enable the user to select more than one security type for a single data field. Thus, if the user wants to encrypt and sign the data, he/she may select “encryption” and “signature” buttons from the provided controls.

The user may enter data, in the data field, after selecting at least one security type to be applied on the data field. The security type may be selected by utilizing the control corresponding to the security type. For example, the user may click on a button corresponding to “masking” of the data of a data field, if he/she wishes to mask the data for the data field. In an embodiment of the invention, the user may also select the security type by selecting the control from a drop-down menu.

It may be appreciated by any person skilled in the art that the controls enable the user to select the security type, of his/her choice, for a particular data field. Further, the controls may enable the user to decide which data exactly needs to be masked, signed, hashed, and encrypted.

Further, routine module 104 may implement a security routine corresponding to the selected security type for the data of the data field present on the form. The security routine may be implemented on data that the user inputs (hereinafter referred to as “original data”) in the data field to produce secured data corresponding to the original data. The security routine may correspond to at least one of masking, signing, hashing, and encryption.

For example, the user may require filling a form having a data field for “gross annual income” of the user. The user may wish to select “masking” as the security type for the data field so as to hide the original data from other people. The user may select a control (from the available controls) corresponding to “masking” by clicking thereon. On selecting the control for masking, routine module 104 may produce a masked data (secured data) by implementing the masking routine for the data (i.e., “gross annual income”) of the data field.

The security routine may produce at least one of masked data, signed data, hashed data, and encrypted data corresponding to respective security type such as “masking”, “signing”, “hashing”, and “encryption”. For instance, the masking routine may be implemented if the user selects “masking” as the security type. In this, a predefined character may replace each character/numeral that the user types in the data field (to enter the data therein). For example, if the predefined character is “@”, all the characters/numerals of the data may be replaced by “@”. For instance, if the user types the data (field value), such as “750,000”, in the data field, the data (field value) may be submitted to the server to replace the original data (“750,000”) with “@@@@@@” as masked data (secured data).

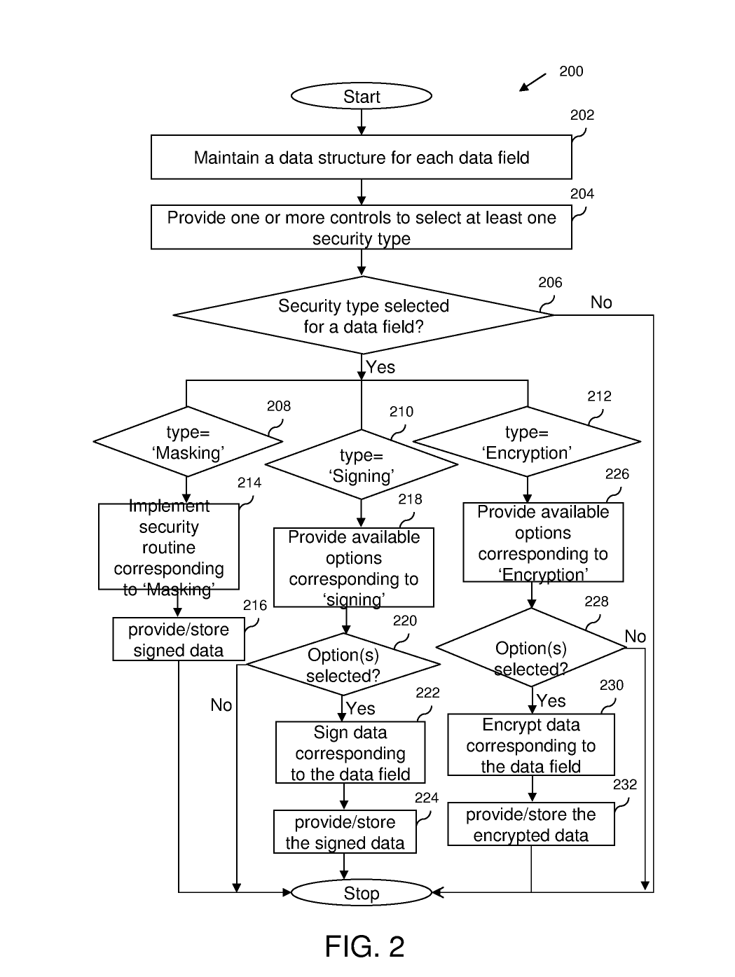

Similarly, routine module 104 may implement signing routine, hashing routine, and encryption routine based on the user's choice for securing the data. In an embodiment, routine module 104 may provide an additional security mechanism to the Web page or the application within a sand box. If the user wishes to sign and/or encrypt the data of the Web page or the application, routine module 104 may implement the signing routine and/or the encryption routine to invoke signing and encryption Application Program Interfaces (APIs). This prevents a direct access to any unknown cryptographic APIs present in a local system. Further, the implementation of routine module 104 is explained further in conjunction with FIG. 2.

Also, the secured data (after implementation of the security routine) may be displayed to the user by a display unit 110 of output module 106. For example, if the user selects “masking” as the security type, the masked data may be displayed to the user on display unit 110 when the user types the data in the data field. Similarly, display module 110 may display, but is not limited to, the data that is signed by the user, encrypted data, masked data and the hashed data.

Also, the secured data may be stored in memory 108. Further, memory 108 may store the data structure maintained by core engine module 102. The data structure may store the secured data along with other attributes (explained earlier) corresponding to each of the data fields.

Memory 108 may store additional features corresponding to the security type of each data field. For example, memory 108 may store features corresponding to “signing”, such as “signing algorithm” and “signing certificate”; features corresponding to “hashing”, such as “hashing algorithm” and the like; and features corresponding to “encryption”, such as “encrypted value” and “encryption certificate”, in the data structure. These features may be based on the user's choice corresponding to the security type for the data field. For example, if the user selects “encryption” (security type), the data field may provide one or more predefined options corresponding to the “encryption”. The user may select at least one option from the predefined options for implementing the security routine corresponding to the security type on the data. For an instance, the predefined options may include “encryption certificates” correspond to “encryption”. The user may choose any of the available “encryption certificates” for encrypting the data of the data field. Thus, memory 108 may store the selected option corresponding to the security type. The predefined options are further explained in conjunction with FIG. 2.

FIG. 2 illustrates a flowchart 200 of a method for securing one or more data fields, in accordance with an embodiment of the invention. The data fields may be secured by providing integrity, confidentiality, and non-repudiation of data corresponding thereto. The data fields may correspond to a form of a Web page or an application. The order in which the method is described is not intended to be construed as a limitation.

At 202, a data structure for each field is maintained. The data structure stores attributes corresponding to each field. The form may be parsed to create a list of all the data fields and their corresponding attributes. The attributes may include, but are not limited to, “field name”, security type, “security algorithm”, “security certificates”, secured data, and “field value”. Security type is a type of security measure that the user wishes to implement on data corresponding to a data field. The security type may include, but is not limited to, “masking”, “signing”, “hashing”, and “encryption”. Further, a security algorithm may correspond to the security type. The user may be provided with one or more security algorithms that the user may select, corresponding to the security type, for the data field. The “security algorithm” attribute may store the algorithm (that is selected by the user) corresponding to the security type. Similarly, the various security certificates may be provided, to the user, corresponding to the security type. Further, the attribute “security certificate” may store the certificate selected by the user from the various security certificates.

The secured data may include data after implementing a security routine on the data, of the data field, that the user wishes to secure (hereinafter referred to as “original data”). The security routine corresponds to the selected security type and other attributes such as, but are not limited to, “security algorithm”, the “security certificate” (as mentioned above), and a “type” of the selected security type. The secured data may include, but is not limited to, masked data, signed data, hashed data, and encrypted data. Thus, the attribute “secured data” may store data after applying a particular security type (as explained earlier in FIG. 1). Furthermore, the “field value” may include data corresponding to the data field. For example, if “signing” is implemented with the type “attached signature”, i.e., in the case where the signature of the user is kept along with the signed data, the data, along with signature, is stored in the “field value”. Similarly, in case of “signing” with the type “detached signature”, i.e., in the case where the signature of the user is kept separate from the signed data, the data alone is stored in the “field value”. Here, the data is the original data that the user wishes to sign.

It may be apparent to a person skilled in the art that in case of signing with type “detached signature”, “the signature”, and “signing certificate” are stored in their respective attributes in the data structure. Further, if “encryption” is used, no content will be stored in the “field value”. Furthermore, if both “signing” and “encryption” are used for the data field, no data is stored in the “field value”. However, the data is stored in “encrypted data” (i.e., “secured data” attribute) with appropriate data secured as for both “signing” and “encryption”.

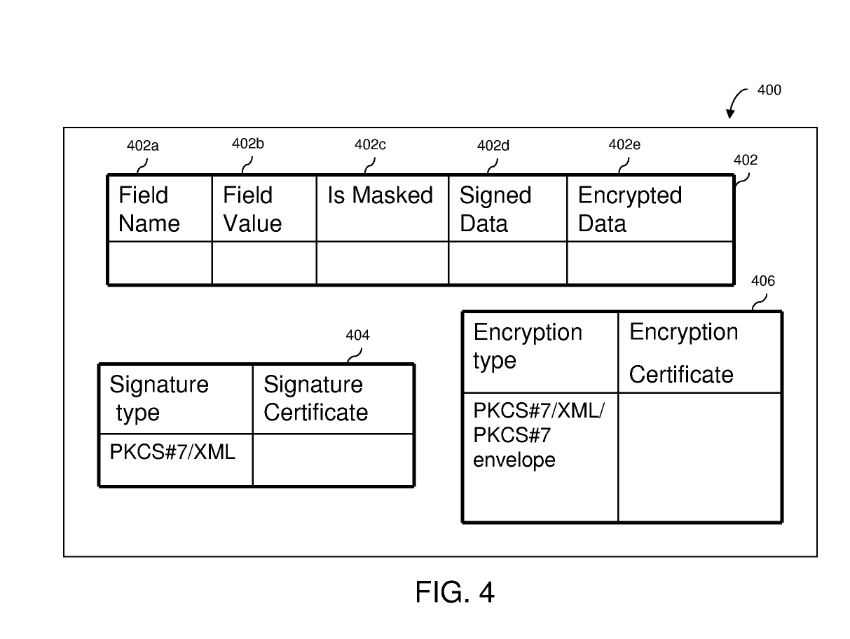

It may be appreciated by a person skilled in the art that the data structure is not limited to the abovementioned attributes. Further, the data structure may include various additional attributes based on one or more parameters such as the user's selection for the security type. Also, various other attributes may be included such as “signing time” to be authenticated along with the data; “countersignature” to be associated with a signature of the signed data (secured data); and the like. In an exemplary embodiment of the invention, the additional attributes may correspond to various types of a particular security type such as “signing” with type “detached signature”, “enveloped signature” and with type “enveloping signature”. In case of the type “enveloped signature”, the signature of the user may be embedded in the signed data. Further, in “enveloping signature”, the signed data may be embedded in the signature. The data structure is explained further in conjunction with FIG. 4.

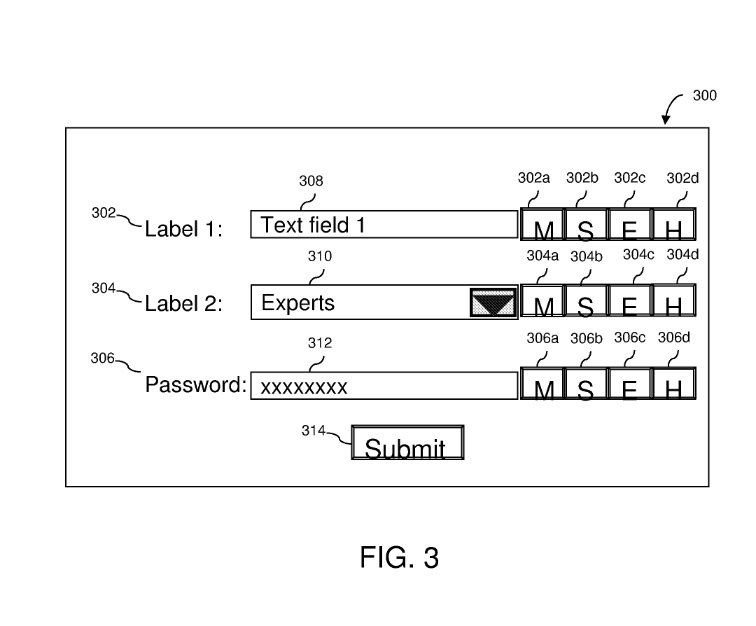

At 204, one or more controls (hereinafter referred to as “controls”) may be provided to enable the user to select at least one security type for the data field. The controls may be provided for each field of the form. Each control may correspond to a security type that the user may select for data corresponding to the data field. The controls may correspond to, but are not limited to, “masking”, “signing”, “hashing”, and “encryption” for producing “masked data”, “signed data”, “hashed data”, and “encrypted data”, respectively, for the data of the data field. The one or more controls are explained further in conjunction with FIG. 3.

At 206, it is determined whether a security type is selected for the data field. The user may select the security type by clicking on a control corresponding to the security type. Further, the user may select more than one control for implementing more than one security type for the data corresponding to a single data field. For example, the user may click on the controls corresponding to “signing” and “encryption” to “sign” and “encrypt” the data within the data field. If the user does not select any security type by utilizing at least one control, the method stops. Further, if the user selects at least one security type by utilizing at least one control, the method proceeds to any one of step 208, step 210, and step 212 based on the selected security type(s).

Method proceeds to step 208 if the security type selected by the user is “masking”. The user may select “masking”, for the data of the data field, by utilizing the control corresponding to “masking”. Further, at step 214, the method implements a security routine for the data field, corresponding to “masking”. Furthermore, a masked data may be produced by implementing the masking routine on the data of the data field. For example, “masking” may be implemented on the data by masking routine if the user selects the control corresponding to “masking”.

The masking routine may be implemented by replacing each character/numeral of the data with a predefined character while the user enters the data in the data field. Further, it may be appreciated by a person skilled in the art that the predefined character may include any special character such as “@”, “$” and the like. Also, all the characters of the data may be replaced by single predefined character so as to produce masked data corresponding to the data that the user enters (original data) in the data field. For example, if the user wishes to mask his/her Social Security Number (SSN) such as “AJATS7689L” and the predefined character for masking is “#”, then the masking routine may produce “##########” as the masked data. In an embodiment, the user may define a particular character for replacing the characters/numerals of the original data before entering the data in the data field.

At step 216, the masked data may be provided to the user. For example, the masked data “##########” may be displayed to the user while the user enters the data in the data field. Additionally, the masked data (secured data) may be stored in the data structure corresponding to the data field (as explained earlier).

Similarly, the method proceeds to step 210 if the security type selected by the user is “signing”. The user may select “signing” for the data of the data field by utilizing the control corresponding to “signing”. Further, at step 218, one or more available predefined options (hereinafter referred to as “options”) are provided to the user. The options may correspond to the security type (i.e., “signing”) that may be selected by the user based on his/her choice. Here, the options may include, but are not restricted to, “signing certificate”, “signing algorithm”, and “signature type” (as explained earlier). These options may provide additional criteria for implementing the security routine, corresponding to “signing” on the data. Such criteria may be utilized while implementing the security routine. For example, if the user selects a particular signing algorithm from the available options, the signing routine may utilize the selected “singing algorithm” for signing the data.

It may be apparent to a person skilled in the art that each “signature type” may be based on a particular standard. For example, “RSA public-key cryptosystem” may be based on RSA standard for “digital signatures”. Further, the “signature type” may follow a particular “signature scheme” to demonstrate the authenticity of the signed data (secured data). In an embodiment, the signature scheme may include, but is not restricted to, “key generation algorithm” from private keys, “signature algorithm” for producing a signed data by utilizing the data (original message) and the generated key, and “signature verification algorithm” for verifying the authenticity of the signed data. A signature scheme may be represented in a particular format such as “PKCS#7/XML”.

At step 220, it is determined whether at least one option is selected from the available options. The user may select at least one option from the available options to enable implementation of “signing routine” corresponding to “signing” (security type). For example, the user may be provided with multiple signing certificates to select at least one among the available certificates. The user may select a particular type of “signing certificate” for “signing routine” for the data. Similarly, the user may wish to select a particular “signing algorithm” and “signature type” from the available options corresponding to the signing routine.

In an embodiment of the invention, “signing algorithm” for signing the data may be selected automatically by selecting a particular “security type”. Based on the selection, the “signing routine” may be implemented on the data. This provides an additional flexibility to the user to decide a way to implement a particular security routine (such as “signing routine”) based on the selected security type (“signing”) for the data of the data field.

If the option is selected from the available options, at step 220, then at step 222, the original data corresponding to the data field may be signed by utilizing the “signing routine”. The signing routine may be executed based on the selection of the at least one option corresponding to “signing”. For example, if the user selects a particular signature type from the available “signature types”, the “signing routine” may be implemented by utilizing the selected “signature type”. Further, if the user selects a particular “signatures certificate” from the available certificates, the “signing routine” may sign the data entered in the data field by utilizing the selected “signature certificate”. Further, a separate security routine may be implemented such as “hashing” for signing the data.

Alternatively, if the user does not select any option from the available options, then, in one embodiment, a “signing routine” with default option(s) may be implemented corresponding to “signing” of the data. The default option(s) may be preset for implementing the “security routine”. Due to this, the “signing routine” may utilize the default option(s) for “signing” the data. Further, in an embodiment, if the option is not selected from the available options, the method stops.

The signed data is displayed to the user at step 224. The user may confirm the security of the displayed signed data based on the user's wish to sign a particular data. In an embodiment, the user may modify the signed data that may be displayed to the user for confirmation. For example, the user may choose different “signing certificate” or “signing algorithm” for signing the data if the user is not satisfied with the displayed signed data. Further, the user may see the exact content of the data that has been signed along with a message to inform the user about the signing of the data.

The signed data may be stored in the data structure corresponding to the data field for which the data is signed. The data structure may store additional information corresponding to the signed data. The additional information may include, but is not limited to, the option(s) selected by the user for implementing the “signing routine” for the data. For example, the option selected by the user, corresponding to the “signing”, such as the “signing certificate” or “signing algorithm” may be stored in the data structure.

The method proceeds to step 212 if the security type selected by the user is “encryption”. The user may select “encryption” for the data of the data field by utilizing the control corresponding to “encryption”. Further, at 226, one or more available predefined options (hereinafter referred to as “options”) corresponding to “encryption” are provided to the user. The user may select at least one option of his/her choice. Here, the options may include, but are not restricted to, “encryption certificate”, “encryption algorithm”, and “encryption type” (as explained earlier). These options may provide additional criteria for implementing the security routine, corresponding to “encryption” on the data.

Similar to “signature type” (as described above), the “encryption type” may follow a particular scheme and may be represented to the user in a particular format such as “PKCS#7/XML/PKCS#7 envelope”. Further, the format may be based on the scheme followed by the “encryption type”. The user may select at least one option from the available options for “encryption” of the data. Further, the options for “encryption” may be provided to the user in a similar way as explained above for “signing”. Accordingly, the options for “encryption” may be understood clearly if read in conjunction with description of the “predefined options” for “signing”.

At step 228, it is determined whether at least one option is selected from the available options for “encryption”. The user may select at least one option from the available set of options to enable implementation of “encryption routine” corresponding to “encryption”. For example, the user may be provided with one or more encryption certificates to select a particular encryption certificate therefrom. Thus, based on the selected encryption certificate, the “encryption routine” is implemented for the data. Similarly, the user may wish to select a particular “encryption algorithm”, “encryption type” from the options corresponding thereto. Based on the selection, the “encryption routine” may be implemented on the data.

If the option corresponding to “encryption” is selected from the options available to the user (for encrypting the data), then at 230, the original data corresponding to the data field may be encrypted by utilizing the selected option corresponding to “encryption”. In this, the “encryption routine” for encrypting the data is implemented by utilizing the selected option. For example, if the user selects a particular “encryption algorithm” from the one or more encryption algorithms (provided to the user), the “encryption routine” may encrypt the data by utilizing the selected “encryption algorithm”.

Alternatively, if the user does not select any option from the options provided for “encryption”, in one embodiment, method stops. In another embodiment, the “encryption routine” may be implemented by utilizing default option(s) that may be preset corresponding to “encryption” of the data.

It may be appreciated by a person skilled in the art that the options may enable the user to specify additional security measures for the data. For example, the user transmits the data to a final server via an intermediary server. Here, the intermediary server does not need to access the data but has to send the data to the final server to complete a particular transaction. In this case, the user may prefer to encrypt the data with the certificate of the final server's certificate. This may be achieved by selecting a particular “encryption certificate” (from the available options) that may correspond to the final server's certificate. Thus, this may prevent the loss of data or decryption of the data by any unlawful entity during transmission.

Further, these options may enable the user to further increase the security for the data. For example, a particular type of “encryption certificate” can be decrypted only by employing the suitable mechanism corresponding to the “encryption certificate”.

The encrypted data (produced at step 230) may be displayed to the user at step 232. In an embodiment, the user may confirm the encrypted data if the data is encrypted appropriately. In an embodiment, the user may be provided with a flexibility to reselect an option from the available set of encryption options corresponding to “encryption”.

The encrypted data may be stored in the data structure corresponding to the data field. Also, additional information corresponding to the encrypted data may be stored in the data structure. The additional information may include, but is not restricted to, the option(s) selected by the user for implementing the “encryption routine”. For example, the data structure may store the at least one option, selected by the user for encrypting the data, such as “encryption certificate” or “encryption algorithm”.

In accordance with the description above, the user may implement one or more security routines for all the data fields of a form.

It may be appreciated by a person skilled in the art that the user may implement more than one security routine on the data. For example, the user may select “encryption routine” and “signing routine” for the data corresponding to a particular data field. The method may thus enable the user to perform both “encryption” and “signing” on the data, thereby providing additional security on the secured data. Further, in an embodiment, the user may also be able to decide the order of implementing more than one security routine on the data. For example, the user may decide to produce secured data by implementing both “encryption routine” and “signing routine” on data. This may be done by first implementing the “encryption routine” on data to produce encrypted data. Thereafter, the “signing routine” may be implemented on the encrypted data to produce signed data. This may ensure both the security and authenticity of the secured data.

Further, it may be appreciated by any person skilled in the art that additional security routines may be provided to the user for securing the data. For example, the user may be enabled to select a security routine for “hashing”. Accordingly, “hashing routine” may be implemented on the data in a similar manner as explained above for “signing” and “encryption”. The “hashing routine” may be implemented on the data to produce a “hashed data” for the field. Furthermore, in an embodiment, “signing routine” and “encryption routine” may utilize “hashing” (hash algorithm(s)) for the data to produce “signed data” and “encrypted data”, respectively.

It may be appreciated by any person skilled in the art that the method is not limited to the order or number of steps as described above. Many other steps may be added or combined for providing additional controls to secure the data or provide numerous combinations of security routines applicable for one or more data fields of a form.

Referring to FIG. 3 and FIG. 4, an exemplary Web form 300 and corresponding exemplary data structure 400 are illustrated, in accordance with an embodiment of the present invention. Specifically, FIG. 3 illustrates an exemplary Web form 300 for implementing the invention as described in detail in conjunction with FIG. 1 and FIG. 2. FIG. 4 illustrates an exemplary data structure 400 for storing attributes corresponding to data fields of a Web form, such as Web form 300, in accordance with an embodiment of the invention.

Web form 300 includes multiple data fields such as data fields 302, 304, and 306. Data fields 302, 304, and 306 correspond to field names “label1”, “label2”, and “password”, respectively, of Web form 300. Further, Web form 300 may be parsed to create a list of data fields 302, 304, and 306 and attributes corresponding to each of them. Further, data structure 400 may be maintained for each field, as illustrated in FIG. 4 by utilizing the list. Data structure 400 may further be maintained by storing attributes, corresponding to the data field. The attributes may include, but are not limited to, field name, field value, and information corresponding to the security type applied on the data of data fields 302, 304, and 306, as explained earlier in conjunction with FIG. 1 and FIG. 2. Data structure 400 depicts “field name” 402a that stores name of a data field present in Web form 300. For example, “field name” 402a may store “label1” corresponding to data field 302.

Further, a user may select one or more security types for data corresponding to one or more data fields 302, 304, and 306 of Web form 300. The security types may include, but are not restricted to, “masking”, “signing”, “encryption”, and “hashing” (represented as M for masking, S for signing, E for encrypting, and H for hashing, in FIG. 3). The security type may be selected to implement one or more security routines on the data. The security routines may include, but are not limited to, “masking routine”, “signing routine”, “encryption routine”, and “hashing routine”. Further, Web form 300 shows various controls corresponding to the security types that the user may utilize for the data corresponding to the data fields. The controls are provided for each data field such as controls 302a, 302b, 302c, and 302d are provided, corresponding to the security types such as “masking”, “signing”, “encryption”, and “hashing”, respectively, for data field 302. Further, controls 304a, 304b, 304c, and 304d are provided, corresponding to the security types for data field 304. Similarly, controls 306a, 306b, 306c, and 306d are provided for data field 306. The user may select one or more security types for implementing the corresponding security routine on the data that the user wishes to secure for maintaining integrity, confidentiality, and non-repudiation thereof.

The user typically has various data entry fields in any form such as Web form 300 where the user can enter the data corresponding to each data fields 302, 304, and 306. Examples of such data entry fields may include, but are not limited to, a textbox, a drop down menu, or other similar means to enable data entry corresponding to data fields 302, 304, and 306. The textbox may be utilized by the user to enter, therein, the data corresponding to the data field. Similarly, the user may choose data, from the drop down menu, corresponding to another data field. Web form 300 shows data entry fields 308, 310, and 312, corresponding to data fields 302, 304, and 306, respectively, to enable the user enter the data therein.

The data may be entered in the data entry fields 308, 310, and 312 to implement, at least one of the security routines thereon. Further, the user may select one or more security types, for each data fields 302, 304, and 306, by clicking on the corresponding controls. The security type(s) may be selected before entering the data in the data field to implement a corresponding security routine on the data. Thus, a user may select control 306a for “masking” the data corresponding to data field 306, i.e., “password”. As a result of this, the security routine corresponding to “masking” may be implemented on the data that the user enters into data entry field 312, (hereinafter referred to as “original data”), to produce a “masked data”. The “masked data” may be shown as “xxxxxxxx” in data entry field 312. Here, the masked data may be produced by replacing each character/numeral of the original data with a predefined character, such as “x”. Accordingly, a corresponding attribute, such as “Is masked” 402c may be stored in data structure 400. In an embodiment of the invention, the attribute “Is masked” 402c may store a Boolean value corresponding to the selection of control 306a.

Similarly, the data may be signed and/or encrypted by utilizing the controls corresponding to “signing” and/or “encryption”, respectively, for data fields 302, 304, and 306. For example, the user may select the control(s) such as control 302b and/or 302c for implementing “signing routine” and/or “encryption routine”, respectively, on the original data of data field 302. Such implementation may produce a secured data that may be stored in data structure 400. For example, data structure 400 depicts attributes such as “signed data” 402d and “encrypted data” 402e that stores the data produced after implementing the “signing routine” and “encryption routine”, respectively.

Further, one or more available predefined options (not shown) may be provided to the user corresponding to the selected security type. The predefined options may be provided to the user when the user selects the security type. For example, if the user selects “encryption” as the security type by selecting a corresponding control, then the predefined options corresponding to “encryption” may be provided to the user. The predefined options that may be provided to the user corresponding to “encryption” may include, but are not limited to, “encryption types” and “encryption certificates”. The user may select at least one option of his/her choice. The selected predefined options may then be stored as attributes in data structure 400. Data structure 400 depicts a table 406 to store the selected predefined option(s) corresponding to “encryption” such as “encryption type” and “encryption certificate”. Similarly, the user may be provided with predefined options corresponding to “signing” when the user selects a control corresponding to “signing” from Web form 300. Further, the user may select at least one option therefrom that may then be stored in data structure 400. Data structure 400 depicts a table 404 to store the selected predefined option(s) corresponding to “signing”, such as “signing type” and “signing certificate”. Further, data structure 400 and its various attributes, such as “field value” 402b, have been explained in detail in conjunction with FIG. 2.

The exemplary embodiment, as described in FIG. 3 and FIG. 4, has been provided purely for illustrative purposes without limiting the scope of the invention.

The invention as described above has numerous advantages. Based on the aforementioned explanation, it can be concluded that the various embodiments of the present invention may be utilized for securing data corresponding to one or more data fields of a web or online form or any form of windows applications, and PDF forms. The window applications may include, but are not restricted to, MS word, MS excel, and MS PowerPoint. The invention may enable a user to select one or more security routines of his/her choice for securing the data of a data field. The invention may enable the user to decide whether or not to apply the security routine, such as “signing”, on the data. Further, the user may view the exact content of the data that can be secured by implementing the security routine(s). For example, the invention may provide exact information about the data that gets signed by the signing routine of the invention. Due to this, the user may feel comfortable about the authentication of the data. Also, by enabling the user to implement a combination of different security routines for each data field of a form, a higher degree of security is provided.

Further, the data may be transferred securely form one point, such as a client, to another point, such as a server. Also, the data may be accessed only by the intended audience of the data; this prevents the leakage of the data while transmitting. For example, the user may wish to submit the data that is not needed by a first server but has to be sent to another server to complete a particular transaction. In this situation, the invention provides flexibility to the user to encrypt the data with the certificate of the final receiving server's certificate. The invention provides one or more options to enable the user to select a particular type of “encryption certificate” that may correspond to the final receiving server's certificate. This may make the user more confident that the data will not be altered during transmission and thereby, keep the user stress free about the data security. Furthermore, this significantly reduces the necessity of any application to write code for client-side encryption and signing for securing the data.

Additionally, the options, such as “signing algorithm”“signing type” and so forth, may enable the user to decide a way to implement the security routine (such as “signing routine”) for the data. This makes the user more comfortable in selecting the option(s).

The Web page or the application is loaded within a sand box without any access to signing and/or encryption APIs present in a local system. Further, the method and the system, provided by the invention, may include one or more security routines that may restrict direct access to unknown cryptographic APIs for securing the data. Each security routine corresponds to the security type that the user may wish to implement for securing the data. Further, the method enables accessing these APIs through the security routines. This eliminates an otherwise need for downloading any component for accessing such APIs. Furthermore, this may prevent any security threat that may occur by accessing such APIs through such components.

Furthermore, the invention provides an interactive and integrated system that may be utilized for implementing the security routine(s) for the data. For example, the system may provide the options to the user for selection. Also, based on selection of one or more options therefrom, the system may further provide various other options corresponding to the user's selection.

Additionally, the invention enables a secure transmission of the data and further increases confidence in the user that the data has been transmitted without any loss (or alteration) therein. The security routine may further implement hashing for additional security of the data. Also, the system allows the users to utilize their choice of embodiments/options of the present invention in an optimal way and with minimum time and effort requirements.

The system for securing data, corresponding to a data field, as described in the present invention or any of its components, may be embodied in the form of a computer system. Typical examples of a computer system include a general-purpose computer, a programmed microprocessor, a micro-controller, a peripheral integrated circuit element, and other devices or arrangements of devices that are capable of securing data corresponding to one or more data fields of a form.

The computer system comprises a computer, an input device, a display unit, and the Internet. The computer further comprises a microprocessor, which is connected to a communication bus. The computer also includes a memory, which may include Random Access Memory (RAM) and Read Only Memory (ROM). The computer system also comprises a storage device, which can be a hard disk drive or a removable storage drive such as a floppy disk drive and an optical disk drive. The storage device can also be other similar means for loading computer programs or other instructions into the computer system. The computer system also includes a communication unit, which enables the computer to connect to other databases and the Internet through an Input/Output (I/O) interface. The communication unit also enables the transfer and reception of data from other databases. The communication unit may include a modem, an Ethernet card, or any similar device which enable the computer system to connect to databases and networks such as Local Area Network (LAN), Metropolitan Area Network (MAN), Wide Area Network (WAN), and the Internet. The computer system facilitates inputs from a user through an input device accessible to the system through an I/O interface.

The computer system executes a set of instructions that are stored in one or more storage elements to process the input data. The storage elements may also hold data or other information as desired. The storage element may be in the form of an information source or a physical memory element present in the processing machine.

The present invention may also be embodied in a computer program product for securing the data corresponding to the data field. The computer program product may include a computer-usable medium having a set program instructions comprising a program code to enable the user select a particular type of “security type” to implement corresponding security routine on the data. The set of instructions may include various commands that instruct the processing machine to perform specific tasks such as tasks corresponding to implementing at least one security routine for the data field to produce corresponding secured data. The set of instructions may be in the form of a software program. Further, the software may be a collection of separate programs, a program module with a large program, or a portion of a program module, as in the present invention. The software may also include modular programming in the form of object-oriented programming. The processing of input data by the processing machine may be in response to user commands, results of previous processing or a request made by another processing machine.

While the preferred embodiments of the invention have been illustrated and described, it will be clear that the invention is not limit to these embodiments only. Numerous modifications, changes, variations, substitutions, and equivalents will be apparent to those skilled in the art without departing from the spirit and scope of the invention, as described in the claims.

What is claimed is:

1. A method for securing data corresponding to one or more data fields of a form, the method comprising:
a. providing one or more controls for enabling selection of at least one security type for each of the one or more data fields, the one or more data fields corresponding to the form; and
b. implementing at least one security routine for the one or more data fields to produce corresponding secured data field, the at least one security routine corresponding to the selected at least one security type.

2. The method of claim 1, wherein the at least one security type comprises at least one of masking, signing, hashing and encrypting.

3. The method of claim 1, wherein the secured data field comprises at least one of a masked data, a signed data, a hashed data and an encrypted data.

4. The method of claim 1 further comprising maintaining a data structure for each of the one or more data fields, the data structure configured for storing attributes corresponding to the each of the one or more data fields.

5. The method of claim 4, wherein the data structure is further configured for storing the secured data field.

6. The method of claim 1, wherein the at least one security routine corresponds to at least one of masking, signing, hashing and encryption.

7. The method of claim 1, wherein the at least one security routine is implemented on the form, the form comprising the one or more data fields.

8. The method of claim 1, wherein implementing the at least one security routine comprises:
a. providing one or more pre-defined options for enabling selection of at least one pre-defined option therefrom, the at least one pre-defined option corresponds to the at least one security type; and
b. executing the at least one security routine based on the selected at least one pre-defined option.

9. The method of claim 8, wherein the one or more pre-defined options comprise at least one of one or more encryption certificates and one or more signing certificates corresponding to encryption and signing respectively.

10. The method of claim 1 further comprising displaying the secured data field based on the implemented at least one security routine.

11. A system for securing data, the system comprising:
a. a core engine module configured for providing one or more controls for enabling selection of at least one security type for one or more data fields, the one or more data fields correspond to a form; and
b. a routine module configured for implementing at least one security routine for the one or more data fields to produce corresponding secured data field, the at least one security routine corresponding to the selected at least one security type.

12. The system of claim 11, wherein the core engine module is further configured to invoke the at least one security routine based on the selection of the at least one security type.

13. The system of claim 11, wherein the at least one security type comprises at least one of masking, signing, hashing and encryption.

14. The system of claim 11, wherein the secured data field comprises at least one of a masked data, a signed data, hashed data and an encrypted data.

15. The system of claim 11, wherein the core engine module is further configured to maintain a data structure for each of the one or more data fields, the data structure configured for storing attributes corresponding to the each of the one or more data fields.

16. The system of claim 15, wherein the data structure is maintained in a memory.

17. The system of claim 15, wherein the data structure is further configured for storing the secured data field.

18. The system of claim 11, wherein the at least one security routine corresponds to at least one of a masking, a signing, a hashing and an encryption.

19. The system of claim 11, wherein the routine module implements the at least one security routine on the data field.

20. The system of claim 11, wherein routine module is further configured to:
a. provide one or more pre-defined options for enabling selection of at least one pre-defined option therefrom, the at least one pre-defined option corresponds to the at least one security type; and
b. execute the at least one security routine based on the selected at least one pre-defined option.

21. The system of claim 20, wherein the one or more pre-defined options comprise at least one of one or more encryption certificates and one or more signing certificates corresponding to encryption and signing respectively.

22. The system of claim 11 further comprising an output module, the output module configured for providing the secured data field based on the implemented at least one security routine.

23. The system of claim 22, wherein the output module provides the secured data field on a display unit.

24. A computer program product for use with a computer, the computer program product comprising a computer usable medium having a computer readable program code embodied therein for securing data corresponding to one or more data fields of a form, the computer readable program code performing:
a. providing one or more controls for enabling selection of the at least one security type for the one or more data fields of the form; and
b. implementing at least one security routine for the one or more data fields to produce corresponding secured data field, the at least one security routine corresponding to the selected at least one security type.

25. The computer program product of claim 24, wherein the at least one security type comprises at least one of a masking, a signing, a hashing and an encryption.

26. The computer program product of claim 24, wherein the secured data field comprises at least one of a masked data, a signed data, a hashed data and an encrypted data.

27. The computer program product of claim 24, wherein the computer program code further performs maintaining a data structure for each of the one or more data fields, the data structure configured for storing attributes corresponding to the each of the one or more data fields.

28. The computer program product of claim 27, wherein the data structure is further configured for storing the secured data field.

29. The computer program product of claim 24, wherein the at least one security routine corresponds to at least one of a masking, a signing, a hashing and an encryption.

30. The computer program product of claim 24, wherein implementing the at least one security routine comprises:
a. providing one or more pre-defined options for enabling selection of at least one pre-defined option therefrom, the at least one pre-defined option corresponds to the at least one security type; and
b. executing the at least one security routine based on the at least one pre-defined option.

31. The computer program product of claim 30, wherein the one or more pre-defined options comprise at least one of one or more encryption certificates and one or more signing certificates correspond to encryption and signing respectively.

32. The computer program product of claim 24, wherein the computer program code further performs displaying the secured data based on the implemented at least one security routine.
